(19) United States
(12) Patent Application Publication
(10) Pub. No.: US 2011/0013091 A1
(43) Pub. Date: Jan. 20, 2011

(54) TUNER CONTROL METHOD AND APPARATUS FOR BROADCAST RECEPTION SYSTEM

(75) Inventor: Ki Young KIM, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/836,819

(22) Filed: Jul. 15, 2010

(30) Foreign Application Priority Data
Jul. 20, 2009 (KR) 10-2009-0065772

(51) Int. Cl. H04N 5/50

(52) U.S. Cl. 348/731; 348/E05.097

(57) ABSTRACT

A method and apparatus for controlling tuners in a broadcast reception system processing broadcast data received in real time, such as digital set-top box and television, is provided to allow a plurality of user terminals to share a limited number of tuners tuned to corresponding channels so as to effectively provide broadcast services. A tuner control method for a broadcast reception system having a plurality of tuners according to the present invention includes determining, if a channel request is received from a user terminal, whether a tuner tuned to a channel indicated by the channel request exists, connecting, if a tuner tuned to the channel exists, the tuner to the user terminal, and providing broadcast data received by means of the tuner to the user terminal

### PRIORITY

This application claims the benefit under 35 U.S.C. §119(a) of a Korean patent application filed on Jul. 20, 2009 in the Korean Intellectual Property Office and assigned Serial No. 10-2009-0065772, the entire disclosure of which is hereby incorporated by reference.

### BACKGROUND OF THE INVENTION

1. Field of the Invention

The present invention relates to a broadcast reception system. More particularly, the present invention relates to a method and apparatus for controlling tuners in a broadcast reception system.

2. Description of the Related Art

FIG. 1 is a schematic diagram illustrating a broadcast reception system of the related art.

Referring to FIG. 1, the broadcast reception system includes a broadcast service provider server 110, a network 120, a tuner control server 130, and at least one user terminal 140 such as a mobile terminal, a television, a personal computer, and the like. The broadcast service provider server 110 provides broadcast data and connects to the tuner control server 130 through the network 120. The tuner control server 130 is connected to at least one of the user terminals 140 via a wired or wireless link so as to provide the broadcast data transmitted by the broadcast service provider server 110.

The tuner control server 130 is a device that includes and controls a plurality of tuners that are tunable to a channel requested by a user for reception of broadcast data. The tuner control server 130 is connected to the user terminals 140 in order to share the broadcast data. A digital set-top box is a representative tuner control server 130.

If a channel is requested by the user terminal 140, the tuner control server 130 controls the tuner to be tuned to the channel requested by the user terminal 140. The operations of the tuner control server 130 are described in more detail with reference to FIG. 2.

FIG. 2 is a block diagram illustrating a configuration of a tuner control server of the related art.

Referring to FIG. 2, the tuner control server 130 includes tuners 210, 220, and 230 assigned to the user terminals 140a, 140b, and 140c respectively. The tuner control server 130 provides the individual user terminals with broadcast data received by means of respective tuners. For example, if the user of user terminal 1 140a has requested channel A, the tuner control server 130 controls such that the tuner 1 210 is tuned to channel A and provides the user of user terminal 1 140a with the broadcast data received by means of the tuner 1 210. Afterward, if a channel switching or navigation request is received from the user terminal 1 140a, the tuner control server 130 controls such that the tuner 1 210 is tuned to the requested channel.

If the user of user terminal 2 140b has requested channel A, the tuner control server 130 controls such that the tuner 2 220 is tuned to channel A and provides the user terminal 2 140b with the broadcast data received by means of the tuner 2 220. Afterward, if a channel switching or navigation request is received from the user terminal 2 140b, the tuner control server 130 controls such that the tuner 2 220 is tuned to the requested channel.

If the user of user terminal n 140n requests channel N, the tuner control server 130 controls such that the tuner n 230 is tuned to channel N. Afterward, if a channel switching or navigation request is received from the user terminal n 140n, the tuner control server 130 controls such that the tuner N 230 is tuned to the requested channel.

As aforementioned, the tuner control server 130 receives a channel request signal from the user terminals 140a, 140b, and 140n and assigns the tuners for the channels requested by the user terminals 140a, 140b, and 140n. At this time, the tuner control server 130 matches the user terminals 140a, 140b, and 140n to the tuners one by one. However, if the number of user terminals that want to receive the broadcast data is greater than the number of tuners, the tuner control server 130 cannot assign a tuner for some user terminals.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for controlling tuners in a broadcast reception system.

In accordance with an aspect of the present invention, a tuner control method for a broadcast reception system having a plurality of tuners is provided. The method includes determining, if a channel request is received from a user terminal, whether a tuner tuned to a channel indicated by the channel request exists, connecting, if a tuner tuned to the channel exists, the tuner to the user terminal, and providing broadcast data received by means of the tuner to the user terminal

In accordance with another aspect of the present invention, a tuner control apparatus is provided. The apparatus includes a tuning unit including at least one tuner tuned to a channel, and a control unit for determining, if a channel request is received from a user terminal, whether a tuner tuned to a channel indicated by the channel request exists, for connecting, if a tuner tuned to the channel exists, the tuner to the user terminal, and for providing broadcast data received by means of the tuner to the user terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description in conjunction with the accompanying drawings, in which:

FIG. 1 is a schematic diagram illustrating a broadcast reception system of the related art;

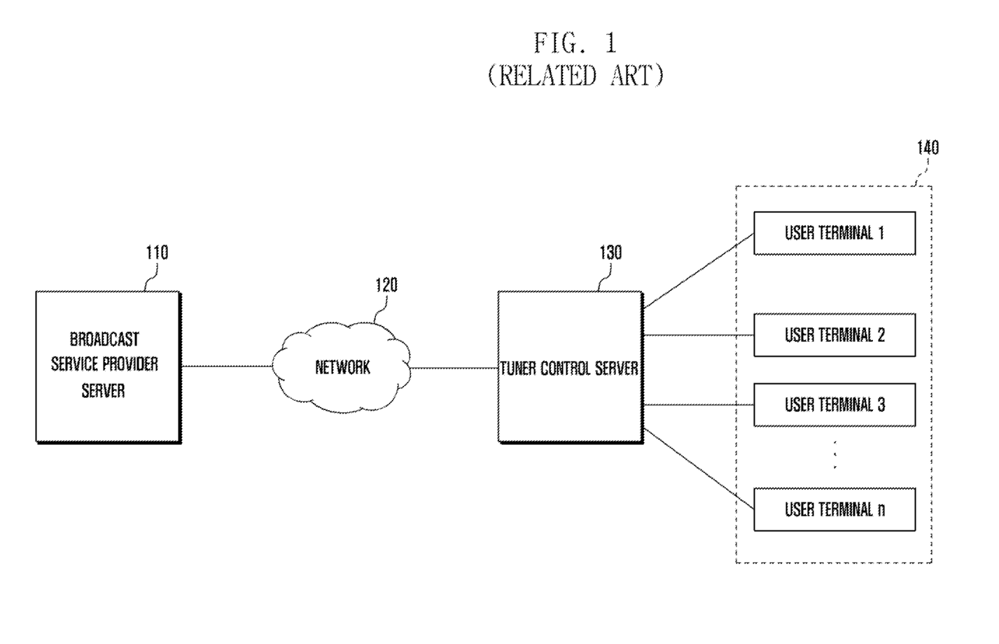

FIG. 2 is a block diagram illustrating a configuration of a tuner control server of the related art;

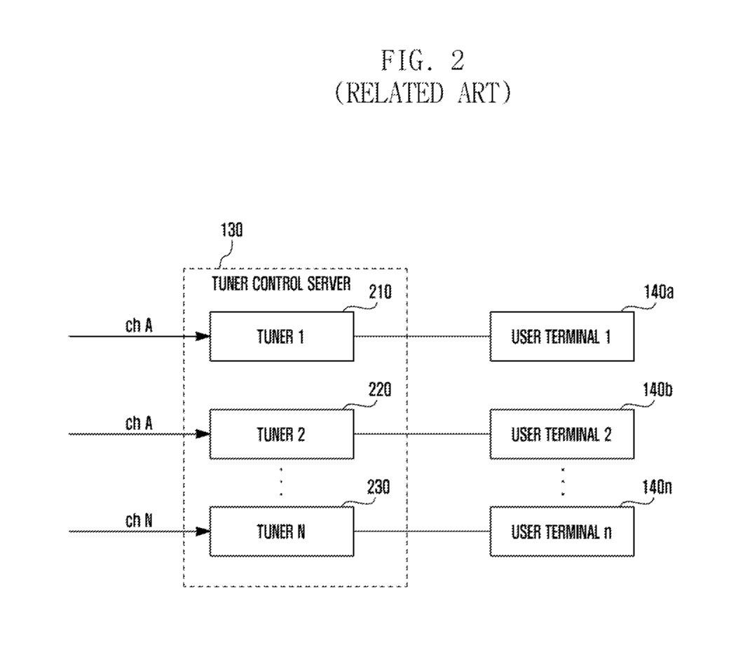

FIG. 3 is a block diagram illustrating a configuration of a tuner control server according to an exemplary embodiment of the present invention;

FIG. 4 is a diagram illustrating a group share Identifier (ID) configuration in a broadcast reception system according to an exemplary embodiment of the present invention;

FIG. 5 is a flowchart illustrating a tuner control method according to an exemplary embodiment of the present invention;

FIG. 6 is a flowchart illustrating steps of a group share ID-based broadcast service provision procedure according to an exemplary embodiment of the present invention; and

FIG. 7 is a flowchart illustrating steps of a group share ID configuration procedure according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details but these are to be regarded as merely exemplary. Accordingly, those of ordinary skill in the art will recognize that various changes and modifications of the embodiments described herein can be made without departing from the spirit and scope of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term ‘tuner control server’ denotes a device that includes at least one tuner and is able to designate the at least one tuner to receive broadcast data corresponding to a desired channel. The tuner control server can be connected to an external terminal through a wired or wireless link to provide broadcast data. As an example, the tuner control server can be represented by a digital set-top box.

The term ‘channel’ denotes a frequency bandwidth allocated per broadcast service provider. Broadcast data provided by the broadcast service provider is received by a broadcast reception system over the channel.

The term ‘user terminal’ denotes a device that is connected to the tuner control server via a wired or wireless link and outputs broadcast data received from the tuner control server. As an example, the user terminal can be a television, a mobile terminal, a laptop computer, a desktop computer, and the like.

Exemplary embodiments of the present invention will be described in greater detail below.

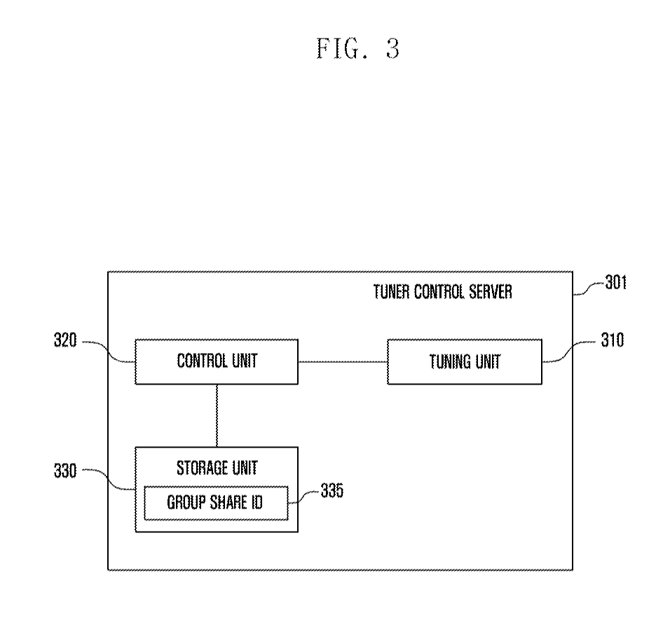

FIG. 3 is a block diagram illustrating a configuration of a tuner control server according to an exemplary embodiment of the present invention.

Referring to FIG. 3, the tuner control server 301 includes a tuning unit 310, a control unit 320, and a storage unit 330.

The tuning unit 310 includes at least one tuner that is tunable to a frequency corresponding to a channel requested by a user terminal connected thereto via a wired or wireless link under the control of the control unit 320. The tuning unit 310 receives broadcast data on the channel to which the tuner is tuned. The at least one tuner is configured with a group share Identifier (ID). In an exemplary embodiment of the present invention, user terminals sharing a group share ID can share a single tuner configured with the group share ID.

The control unit 320 controls the states and operations of the function blocks of the tuner control server 301. In an exemplary implementation, if a channel request is received from a user terminal, the control unit 320 controls the tuning unit 310 to assign a tuner for the requested channel. The control unit 320 also configures a group share ID of the tuner assigned for the channel. The control unit 320 connects a user terminal to the tuner for supplying the broadcast data and transfers the group share ID to the user terminal. The control unit 320 also stores the group share ID of the tuner in the storage unit 330. The control unit 320 supplies broadcast data received by means of the tuner assigned for the channel to the at least one user terminal having the same group share ID. Although it is described that the group share ID is configured when the tuning unit 310 is initially tuned to the channel requested by the first user terminal, the present invention is not limited thereto. For example, if a second user terminal requests a channel while the tuner is tuned to the channel requested by a first user terminal, the control unit 320 can reconfigure the group share ID of the corresponding tuner. In this case, the control unit 320 sends the reconfigured group share ID to the first user terminal already using the channel and to the second user terminal that requested the channel.

If a channel request is received from a user terminal, the control unit 320 checks the tuning unit 310 to determine whether there is a tuner assigned for the requested channel. If there is a tuner assigned for the requested channel, the control unit 320 connects the tuner to the user terminal to supply the broadcast data received by means of the tuner. At this time, the control unit 320 sends the group share ID configured at the tuner to the user terminal requesting the channel. Next, the control unit 320 supplies the broadcast data received by means of the tuner configured with the group share ID to the user terminals sharing the group share ID. Here, the group share ID is the identifier that enables multiple user terminals to share a single tuner.

The control unit 320 determines the priority of the at least one user terminal having the same group share ID. The control unit 320 can grant a tuner control right to the user terminal having the highest priority. The tuner control right is the right to control the channel to which the tuner is tuned. The user terminal having the tuner control right can control the tuner to switch and navigate between channels. Accordingly, the control unit 320 can change the channel to which the tuner is tuned according to a channel switching signal received from the user terminal having the channel control right. The control unit 320 also can control to navigate between available channels according to the channel navigation signal received from the user terminal having the channel control right.

If a channel switching signal is received from the user terminal having the tuner control right, the control unit 320 controls the tuner 310 to be tuned to the frequency indicated by the channel switching signal. The control unit 320 supplies the broadcast data received on the switched channel to the user terminals sharing the tuner with the tuner share ID as well as the user terminal having the tuner control right.

As an example, it is assumed that a first tuner, designated as tuner 1, is shared by multiple user terminals (user terminal 1, user terminal 2, and user terminal 3) and tuned to channel CH-A and the user terminal 1 has the tuner control right. If the user terminal 1 sends a channel switching signal for switching from the current channel CH-A to a new channel CH-B, the control unit 320 controls the tuning unit 310 to tune the tuner 1 to the frequency corresponding to channel CH-B. The control unit 320 supplies the broadcast data received on channel CH-B to the user terminal 1, user terminal 2, and user terminal 3.

In an exemplary implementation, if the channel switching signal is received, the control unit 320 supplies broadcast data received on the switched channel to the user terminal having the tuner control right. The control unit 320 can also determine if another tuner is tuned to the previous channel and supply the broadcast data received by means of the other tuner to the user terminals that have shared the previous tuner with the user terminal having the tuner control right.

As an example, it is assumed that the tuner 1 and the tuner 3 are tuned to channel CH-A, the tuner 1 is serving multiple user terminals including the user terminal 1 that has the tuner control right, the user terminal 2, and the user terminal 3, and the tuner 3 is serving the user terminal 4. If the user terminal 1 sends a channel switching signal for switching the channel of the tuner 1 from CH-A to CH-B, the control unit 320 controls such that the tuner 1 is tuned to channel CH-B. The control unit 320 supplies the broadcast data received on channel CH-B to the user terminal 1.

The control unit 320 also determines if a tuner is tuned to the previous channel CH-A. Because the tuner 3 is tuned to channel CH-A, the control unit 320 transfers the group share ID assigned to the tuner 3 to the user terminal 2 and the user terminal 3. Because the group share ID of tuner 3 is transferred to the user terminal 2 and the user terminal 3, the control unit 320 supplies broadcast data received by the tuner 3 tuned to channel CH-A to the user terminal 2, the user terminal 3, and the user terminal 4.

In another exemplary implementation, if the channel switching signal is received, the control unit 320 can supply the broadcast data of the previous channel to the user terminals except for the user terminal having the tuner control right by means of a tuner that has not been tuned for any channel. As an example, it is assumed that the tuner 1 is tuned to channel CH-A and shared by multiple user terminals (user terminal 1 having the tuner control right for the tuner 1, the user terminal 2, and the user terminal 3) and tuner 4 is not tuned for any channel. If the user terminal 1 sends a channel switching signal for switching the channel from CH-A to CH-B, the control unit 320 controls such that the tuner 1 is tuned to channel CH-B and supplies the broadcast data received on channel CH-B to the user terminal 1. The control unit 320 also determines whether there is any tuner that is currently not tuned to any channel. Since the tuner 4 is not currently tuned to any channel, the control unit 320 controls such that the tuner 4 is tuned to channel CH-A. The control unit 320 configures a group share ID of the tuner 4 and transfers the group share ID to the user terminal 2 and the user terminal 3 and supplies the broadcast data received by the tuner 4 to the user terminal 2 and the user terminal 3.

The storage unit 330 stores application programs required for performing functions of the tuner control server 301 and data generated while running the specific functions. The storage unit 330 also stores the group share IDs 335 assigned to the respective tuners. The group share IDs 335 can be preset for the respective tuners at the manufacturing stage of the tuner control server 301. The group share IDs 335 can be stored in the storage unit 330 when the tuners are tuned to the respective channels in response to the channel switching signals. In this case, the group share ID 335 can be configured to be deleted from the storage unit 330 automatically in response to a channel release for all of the user terminals sharing a tuner.

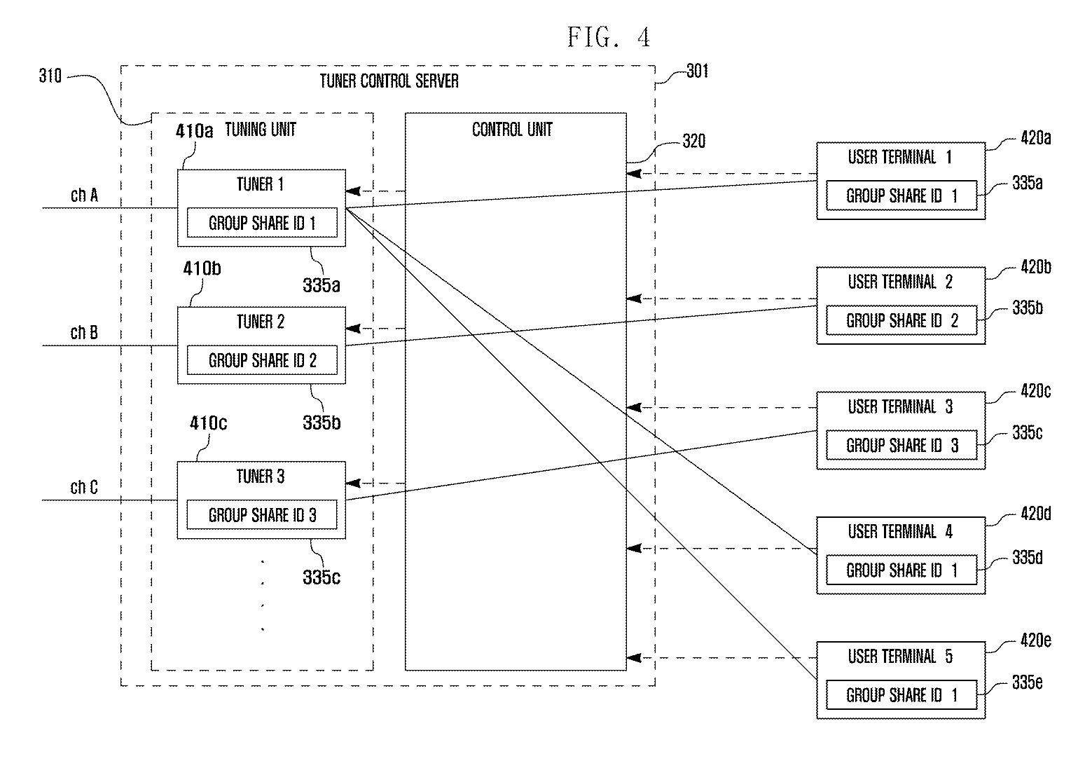

FIG. 4 is a diagram illustrating a group share ID configuration in a broadcast reception system according to an exemplary embodiment of the present invention.

Referring to FIG. 4, the tuner control server 301 includes a tuning unit 310 and a control unit 320. The tuning unit 310 includes tuner 1 410a, tuner 2 410b, and tuner 3 410c. The tuner control server 301 is connected to a plurality of user terminals, i.e., user terminal 1 420a, user terminal 2 420b, user terminal 3 420c, user terminal 4 420d, and user terminal 5 420e. The solid lines between the tuners and user terminals denote broadcast data supply, and the dotted lines between the control unit 320 and the user terminals and the control unit 320 and tuners denote flows of control signals. The tuners 410a, 410b, and 410c are configured with group share IDs 335a, 335b, and 335c, respectively.

The control unit 320 provides at least one user terminal that has a group share ID configured at a corresponding tuner with broadcast data received by means of the tuner. As shown in FIG. 4, the tuner 1 410a, configured with the group share ID 1 335a, is shared by the user terminals 420a, 420d, and 420e having the same group share ID. That is, the control unit 320 controls such that each tuner provides the broadcast data received on the tuned channel to at least one user terminal having the group share ID configured at the tuner. For example, the control unit 320 controls such that the tuner 1 410a, tuned to channel CH-A, provides the broadcast data received on channel CH-A to the user terminals 420a, 420d, and 420e sharing the group share ID 1 335a configured at the tuner 1 410a.

If the user terminal 2 420b requests channel switching to channel CH-B, the control unit 320 controls the tuning unit 310 such that the tuner 2 410b is tuned to channel CH-B. At this time, the control unit 320 configures the tuner 2 410b with the group share ID 2 335b and sends the group share ID 2 335b to the user terminal 2 420b.

If the user terminal 3 420c requests channel switching to channel CH-C, the control unit 320 controls the tuning unit 310 such that the tuner 3 410c is tuned to channel CH-C. The control unit 320 configures the tuner 3 410c with the group share ID 3 335c and sends the group share ID 3 335c to the user terminal 3 420c.

The control unit 320 can determine the priorities of the user terminals 420a, 420d, and 420e sharing the tuner 1 410a that is tuned to channel CH-A and grant the tuner control right to the user terminal having the highest priority. The priority can be determined in order of the channel request time or according to the type of user terminal. In case of determining the priority according to the type of user terminal, the control unit 320 predetermines the priorities of the types of the terminals and grants the tuner control right to the user terminal having the highest priority type regardless of the duration for which each user terminal has been receiving service from the tuner. Assuming that television has the first level priority, mobile terminal has the second level priority, and computer has the third level priority, the control unit 320 determines whether each user terminal attached to the tuner is a television, a computer, or a mobile terminal and determines the priorities of the user terminals according to the result. The type of the user terminal can be identified using a device identifier provided by the user terminal The priorities of the device types can be configured by the user or fixed at the manufacturing stage of the tuner control server.

Once the tuner control right has been granted to a user terminal, the control unit 320 of the tuner control server 301 controls the tuning unit 310 according to the channel switching signal or the channel navigation signal transmitted by the user terminal having the tuner control right such that the tuner is tuned and navigated to a specific channel. At this time, the control unit 320 can supply the broadcast data received on the switched channel to another user terminal sharing the tuner. Also, the control unit 320 can search for another tuner tuned to the previous channel before the channel switching and then supply the broadcast data received by the newly found tuner tuned to the previous channel to the other user terminals. Also, the control unit 320 can search for an idle tuner that is not tuned to any channel yet, and control the idle tuner to be tuned to the previous channel and supply the broadcast data received by means of the newly tuned tuner to the other user terminals.

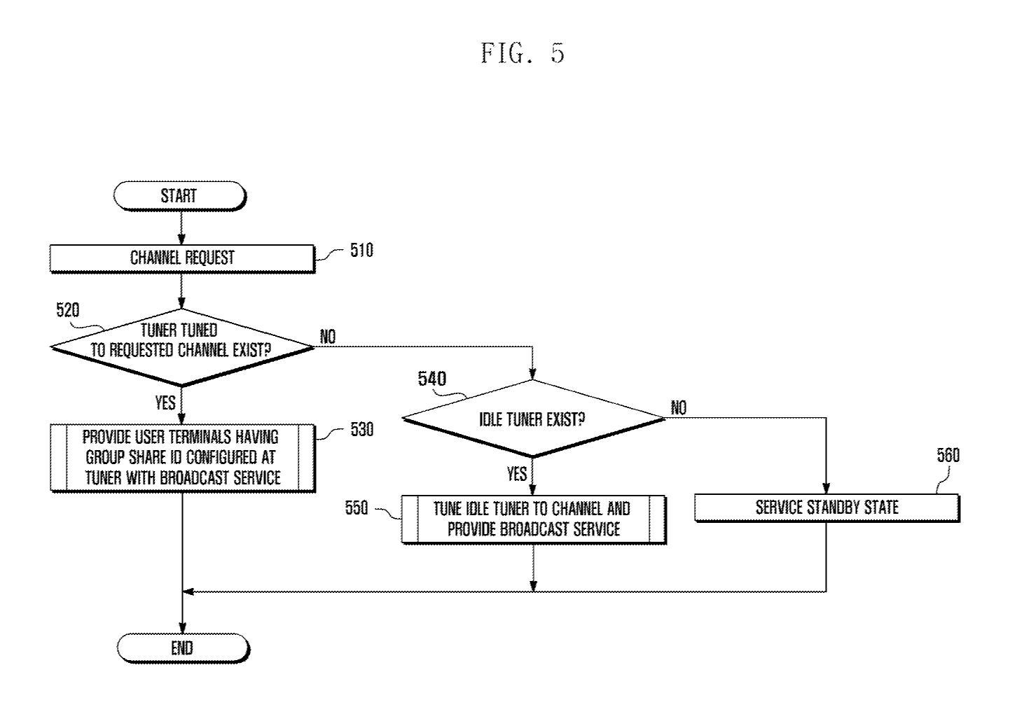

The following descriptions are made of exemplary methods for multiple user terminals to share a single tuner with reference to FIGS. 5 to 7.

FIG. 5 is a flowchart illustrating a tuner control method according to an exemplary embodiment of the present invention.

Referring to FIG. 5, the tuner control server 301 detects a channel request transmitted by a user terminal in step 510 and determines whether there is a tuner tuned to the requested channel in step 520. If there is a tuner tuned to the requested channel, the tuner control server 301 connects the tuner to the user terminals having the group share ID configured at the tuner and provides the user terminals having the group share ID with the broadcast service in step 530.

If it is determined in step 520 that there is no tuner tuned to the requested channel, the tuner control server 301 determines whether there is an idle tuner in step 540. That is, the tuner control server 301 searches the tuning unit for at least one idle tuner to assign the requested channel. If there is an idle tuner, the tuner control server 301 controls to tune the idle tuner to the requested channel and provide the broadcast service in step 550.

If it is determined in step 540 that there is no idle tuner, the tuner control server 301 controls to enter a service standby state. At this time, the tuner control server 301 can transfer a message notifying the user terminal of the channel tuning unavailability. In this case, the tuner control server 301 stands by until an idle tuner is detected or a new channel request signal is received from the user terminal.

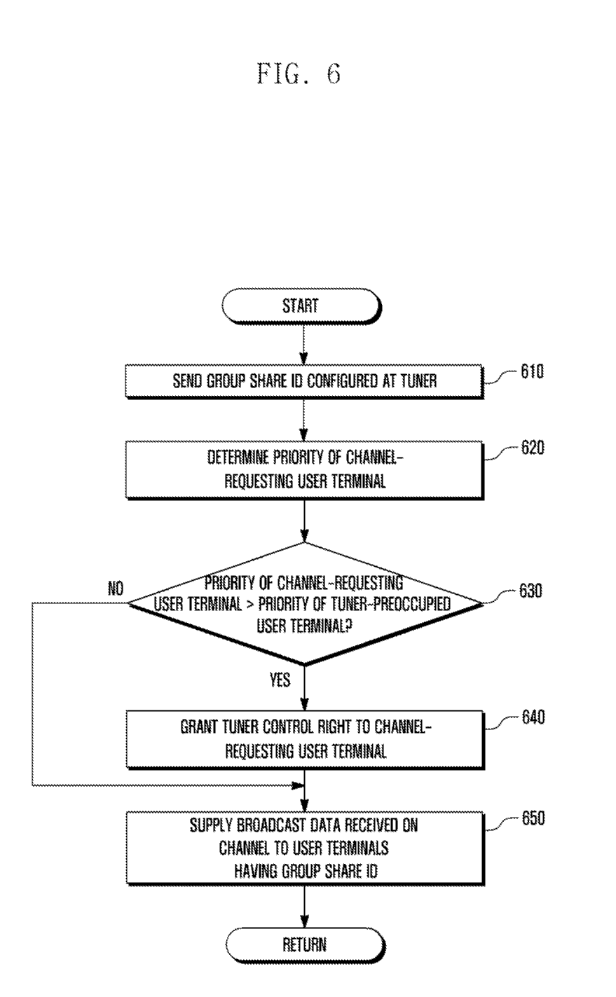

An exemplary group share ID-based broadcast service provision is described hereinafter in more detail with reference to FIG. 6.

FIG. 6 is a flowchart illustrating steps of a group share ID-based broadcast service provision procedure according to an exemplary embodiment of the present invention.

Referring to FIG. 6, if there is a tuner tuned to the requested channel, the tuner control server 301 determines the group share ID configured at the tuner and sends the group share ID to the user terminal which has transmitted the channel request in step 610. The tuner control server 301 connects the user terminal to the tuner and the user terminal saves the group share ID received from the tuner control server 301. The group share ID stored in the user terminal may be deleted when a channel switching or channel release occurs.

The tuner control server 301 determines the priority level of the user terminal which has transmitted the channel request in step 620. In step 630, the tuner control server 301 determines whether the priority level of the channel-requesting user terminal is higher than that of the user terminal that currently occupies the tuner. If priority of the channel-requesting user terminal is higher than that of the user terminal preoccupying the tuner, the tuner control server 301 grants the tuner control right to the channel-requesting user terminal in step 640. In step 650, the tuner control server 301 supplies the broadcast data received on the requested channel to at least one user terminal having the group share ID configured at the tuner. On the other hand, if it is determined in step 630 that the priority of the channel-requesting user terminal is less than that of the user terminal preoccupying the tuner, the tuner control server 301 proceeds directly to step 650. Steps 620 to 650 can be described with an exemplary case as follows.

The priority level is used to determine the user terminal to which the tuner control right is granted. The priorities of the user terminal to a tuner can be determined in order of the number of times that the user terminals have requested the channel. Also, the priority can be determined according to the device types, i.e. whether the user terminal is a television, a computer, or a mobile terminal As an example, the priority level of a television may be set to 1, the priority level of a computer may be set to 2, and the priority level of a mobile terminal may be set to 3, and the mobile terminal has preoccupied the channel. If a television requests the channel preoccupied by the mobile terminal, the tuner control server 301 sends the group share ID configured at the tuner to the television. Next, the tuner control server 301 determines the priority levels of the television and the mobile terminal. Since the priority level of the television is higher than that the mobile terminal, the tuner control server 301 grants the tuner control right to the television. The user terminal having the tuner control right can change the channel to which the tuner is tuned. That is, if a channel switching request signal for switching the current channel from CH-A to CH-B is received from the television, the tuner control server 301 controls such that the tuner releases channel CH-A and is tuned to the requested channel CH-B. At this time, the tuner control server 301 can supply the broadcast data of the switched channel CH-B to the mobile terminal which has shared the tuner with the television or the broadcast data received on another tuner tuned to channel CH-A.

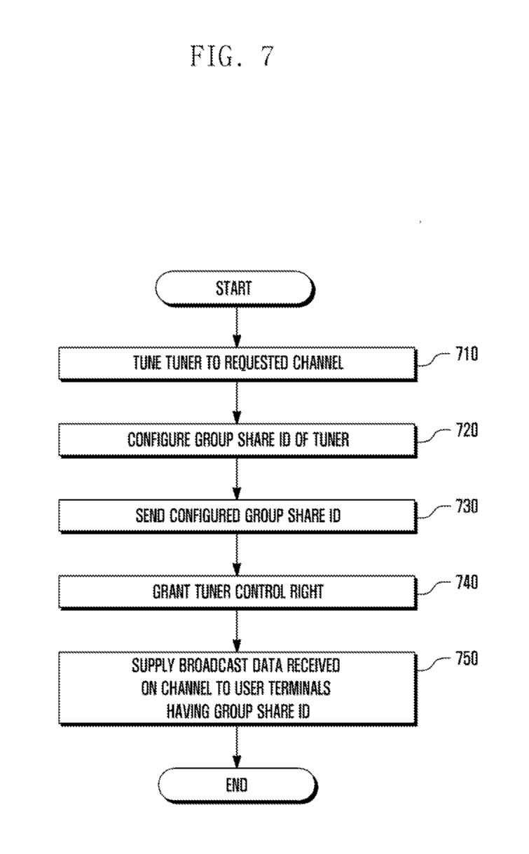

An exemplary group share ID configuration and tuner sharing procedure is described hereinafter in more detail with reference to FIG. 7.

FIG. 7 is a flowchart illustrating steps of a group share ID configuration procedure according to an exemplary embodiment of the present invention.

Referring to FIG. 7, if there is no tuner tuned to a requested channel, the tuner control server 301 determines whether there is an idle tuner. If there is an idle tuner, the tuner control server 301 controls such that the idle tuner is tuned to the requested channel in step 710. Here, tuning to the requested channel means tuning the tuner to a frequency corresponding to the requested channel. In step 720, the tuner control server 301 configures the group share ID of the tuner tuned to the requested channel. The tuner control server 301 connects the tuner to the channel-requesting user terminal and sends the group share ID configured at the tuner to the user terminal connected to the tuner in step 730. The tuner control server 301 grants the tuner control right to the corresponding user terminal in step 740 and provides the user terminal with the broadcast service received on the channel in step 750.

As described above, an exemplary tuner control method and apparatus of the present invention enables multiple user terminals to access a limited number of tuners in a broadcast reception system for processing broadcast data. An exemplary tuner control method and apparatus of the present invention is capable of providing broadcast data to a plurality of user terminals connected to a tuner control server in real time. An exemplary tuner control server of the present invention can effectively process channel requests received from a number of user terminals that is greater than the number of tuners.

While the invention has been shown and described with reference to certain exemplary embodiments thereof, it will be understood by those skilled in the art that various changes in form and details may be made therein without departing from the spirit and scope of the invention, as defined by the appended claims and their equivalents.

What is claimed is:

1. A tuner control method for a broadcast reception system having a plurality of tuners, the method comprising:
determining, if a channel request is received from a user terminal, whether a tuner tuned to a channel indicated by the channel request exists;
connecting, if a tuner tuned to the channel exists, the tuner to the user terminal; and
providing broadcast data received by means of the tuner to the user terminal.

2. The method of claim 1, wherein the connecting of the tuner to the user terminal comprises:
sending a group share Identifier (ID) configured at the tuner tuned to the channel to the user terminal; and
supplying the broadcast data to at least one user terminal having the group share ID.

3. The method of claim 1, further comprising:
determining, if no tuner tuned to the channel exists, whether an idle tuner exists;
configuring, if an idle tuner exists, a group share Identifier (ID) at the idle tuner; and
sending the group share ID of the idle tuner to the user terminal

4. The method of claim 1, further comprising:
determining a priority of the user terminal; and
granting a tuner control right to the user terminal depending on the determined priority.

5. The method of claim 4, wherein the priority is determined by one of order of time when the channel request is received and type of the user terminal

6. The method of claim 4, further comprising, after the connecting of the tuner to the user terminal:
receiving a request for a channel change from the user terminal;
determining if the user terminal includes the tuner control right; and
changing to the requested channel if the terminal includes the tuner control right.

7. The method of claim 1, further comprising, after the connecting of the tuner to the user terminal:
receiving a request for a channel change from a second user terminal;
determining if a priority of the second user terminal is greater than a priority of the user terminal currently connected to the tuner; and
switching to the requested channel if the priority of the second user terminal is greater than the priority of the user terminal currently connected to the tuner.

8. The method of claim 7, wherein the priority is determined by one of order of time when the channel request is received and type of the user terminal

9. A tuner control apparatus, the apparatus comprising:
a tuning unit including at least one tuner for tuning to a channel; and
a control unit for determining, if a channel request is received from a user terminal, whether a tuner tuned to a channel indicated by the channel request exists, for connecting, if a tuner tuned to the channel exists, the tuner to the user terminal, and for providing broadcast data received by means of the tuner to the user terminal.

10. The apparatus of claim 9, wherein the control unit sends a group share Identifier (ID) configured at the tuner tuned to the channel to the user terminal and supplies the broadcast data to at least one user terminal having the group share ID.

11. The apparatus of claim 10, wherein the control unit determines, if no tuner tuned to the channel exists, whether an idle tuner exists, configures, if an idle tuner exists, a group share ID at the idle tuner, and sends the group share ID of the idle tuner to the user terminal.

12. The apparatus of claim 9, wherein the control unit determines a priority of the user terminal and grants a tuner control right to the user terminal depending on the determined priority.

13. The apparatus of claim 12, wherein the priority is determined by one of order of time when the channel request is received and type of the user terminal

14. The apparatus of claim 12, wherein the control unit, after connecting the tuner to the user terminal, receives a request for a channel change from the user terminal, determines if the user terminal includes the tuner control right, and changes to the requested channel if the terminal includes the tuner control right.

15. The apparatus of claim 9, wherein the control unit, after connecting the tuner to the user terminal, receives a request for a channel change from a second user terminal, determines if a priority of the second user terminal is greater than a priority of the user terminal currently connected to the tuner, and switches to the requested channel if the priority of the second user terminal is greater than the priority of the user terminal currently connected to the tuner.

16. The apparatus of claim 15, wherein the priority is determined by one of order of time when the channel request is received and type of the user terminal
